(19) United States
(12) Patent Application Publication
(10) Pub. No.: US 2024/0314136 A1
(43) Pub. Date: Sep. 19, 2024

(54) METHOD FOR CONTROLLING THE ACCESS OF A USER TO A NETWORK, NETWORK, AND COMPUTER PROGRAM

(71) Applicant: Consumer Marketing Borell GmbH, Stutensee (DE)

(72) Inventor: Rainer BORELL, Stutensee (DE)

(73) Assignee: Consumer Marketing Borell GmbH, Stutensee (DE)

(21) Appl. No.: 18/677,472

(22) Filed: May 29, 2024

Related U.S. Application Data
(63) Continuation of application No. PCT/EP2022/082144, filed on Nov. 16, 2022.

(30) Foreign Application Priority Data
Nov. 29, 2021 (DE) 10 2021 131 272.8

(51) Int. Cl. H04L 9/40

(52) U.S. Cl. CPC H04L 63/104

(57) ABSTRACT

A method for controlling the access of a user to a network. The following steps are provided: determining a monitoring parameter which corresponds to the access of the user to at least one program and/or at least one service and/or at least one file of the network and/or location information assigned to the network and/or to the user, comparing the monitoring parameter with a first threshold and cutting off the access of the user to the network on the basis of the result of the comparison. A network is also provided comprising at least one data processing device which is designed to carry out the method according to the invention and to a computer program containing program code, the computer program being designed to carry out the steps of the aforementioned method.

This nonprovisional application is a continuation of International Application No. PCT/EP2022/082144, which was filed on Nov. 16, 2022, and which claims priority to German Patent Application No. 10 2021 131 272.8, which was filed in Germany on Nov. 29, 2021, and which are both herein incorporated by reference.

### BACKGROUND OF THE INVENTION

### Field of the Invention

The invention relates to a method for controlling the access of a user to a network, a network with at least one data processing device and a computer program with program code.

### Description of the Background Art

Methods for controlling the access of a user to a network are known from the conventional art. These methods are intended to protect the network from unauthorized access by the user so that the user does not interact with the network files without authorization. The known procedures provide protection in particular against so-called ransomware attacks, in which the user as an attacker gains access to the network, copies files from the network to their own server and then encrypts the network files to such an extent that the operator of the network can no longer restore the files themselves. To restore the data, the user demands a large sum of money from the network operator. In another variant of ransomware attacks, a trustworthy user executes a malicious program (ransomware), after which the attacker copies and encrypts the network files, largely undetected by the user. Even with this variant, paying the amount of money demanded by the attacker is often the only way to restore the data, although there is no guarantee that the attacker will keep their word and actually restore the data after receiving the requested amount of money. Due to the at least temporary loss of data and the in any case considerable sum of money demanded, the operator of the network suffers immense damage.

To control access to a network, in particular to protect against the attacks mentioned, known procedures provide that the user of a network can only execute programs approved by a network administrator, which is also referred to as whitelisting. The execution of unauthorized programs is blocked. The disadvantage of these methods is that all of the permitted programs must be explicitly approved by a network administrator, especially after each program update. The list of allowed programs must therefore be updated almost daily, making it almost impossible to keep it up to date. This severely limits the practical applicability of these procedures. In addition, whitelisting-based procedures cannot prevent the creation of unauthorized file copies. An attacker can still steal files and use them to harm the organization.

### SUMMARY OF THE INVENTION

It is therefore an object of the invention to develop an improved method for controlling the access of a user to a network, wherein the method in particular eliminates the aforementioned disadvantages of the conventional art and offers reliable protection against attacks.

The object of the invention is achieved, in an example, by a method for controlling the access of a user to a network with the following steps: determining a monitoring parameter corresponding to the access of the user to at least one program and/or at least one service and/or at least one file of the network and/or location information associated with the network and/or the user; comparing the monitoring parameter with a first limit value; and disconnecting the access of the user to the network depending on the result of the comparison, in particular if the monitoring parameter is greater than the first limit value.

In addition, the object is achieved by a network with at least one data processing device which is designed to carry out the method according to the invention. In addition, the object is achieved by a computer program having program code, which computer program is configured to carry out the steps of the method according to the invention when the computer program is executed on a computer or a corresponding computing unit.

The invention is based on the basic idea that unwanted access by a user, also called a client, to the network, in particular a ransomware attack on the network, can be reliably detected by the user's interaction with the network, in particular with its programs, services and/or files. By quantifying this user interaction, which is technically implemented in the sense of the invention by determining the monitoring parameter, unwanted access can be detected in a technically simple manner by comparing the monitoring parameter with the first limit value. If the monitoring parameter is, for example, greater than the first limit value, the method according to the invention recognizes the access of the user to the network as a threat and causes the access of the user to the network to be disconnected and, in particular, the immediate and future denial of file access in order to prevent further malicious actions by the user on the network as quickly as possible. In this respect, the method according to the invention enables active protection of the data of the network, in particular of a data processing device assigned to it. The disconnection according to the invention of the access of the user to the network ensures that no more data exchange takes place between the user, who was identified as a potential attacker through the comparison, and the network or at least part of it. By completely preventing data exchange, effective protection against further attacks is ensured, especially compared to known methods that only block and/or redirect suspicious network packets. Since these known methods still allow data to be exchanged between the suspicious user and the network, in particular its data processing equipment, namely in the form of non-suspicious network packets, the risk of further attacks by the same user still exists with the known methods. However, this is prevented by the present invention.

In order to ward off a threat as quickly as possible, the comparison of the monitoring parameter with the first limit value and/or the disconnection of the access of the user to the network, in particular to the network data, preferably to the data processing device, can be carried out automatically.

In the sense of the invention, the network can have at least one, in particular more than one data processing device, which is designed, for example, as a computer, mobile phone, tablet and/or vehicle computer. At least two data processing devices can be connected to each other via cable and/or wirelessly in such a way that data exchange is possible. The data processing device of the network preferably has a file management service, for example a file server.

The method is preferably designed to control the access of a user to a data processing device of the network, wherein the monitoring parameter corresponds to the access of the user to at least one program and/or at least one service and/or at least one file of the data processing device and/or location information associated with the data processing device and/or the user and/or wherein the access of the user to the data processing device is disconnected depending on the result of the comparison.

The method according to the invention can run at the level of the data processing device which is to be protected against unauthorized access, in particular at the level of the file management service of the data processing device of the network.

The determination of the monitoring parameter may depend on the access of the user to at least one program, in particular to at least one service of the network, in particular of the data processing device. If the user deactivates at least one predefined program, in particular a predefined service of the network, in particular of the data processing device, the monitoring parameter is preferably set to a predefined value such that the user's access to the network, in particular to the data processing device, is disconnected, for example by a value that is greater than the first limit value. In another example of the invention, the monitoring parameter can have a Boolean value which, for example, is set to the value “true” when the service is deactivated, which can be determined by an appropriately designed comparison. As already mentioned, in this case the access of a user to the network, in particular to the data processing device, is registered as a threat situation, and consequently, the method according to the invention disconnects the access of the user to the network, in particular to the data processing device.

Services of the network, in particular of the data processing device, are, as is well known, a sub-type of programs which generally deal with the administration of the network, in particular of the data processing device. Common examples are system services of the network, in particular of the data processing device, such as the “Volume Shadow Copy” service of Windows networks and/or a Windows data processing device, which is deactivated by the user, especially at the beginning of a ransomware attack, in order to make it more difficult to restore the network data. Since the deactivation of the (system) service “Volume Shadow Copy” corresponds to a typical behavior pattern of a ransomware attack, the method according to the invention is able to reliably recognize this behavior pattern and to disconnect the access of the user to the network, in particular the data processing device, in this case, so that further damaging actions are avoided. The same applies to switching off a firewall of the network, in particular of the data processing device, which also corresponds to a system service of the network, in particular of the data processing device, within the meaning of the invention. Another service within the meaning of the invention can be a service associated with antivirus software.

In addition, the determination of the monitoring parameter may depend on the access of the user to at least one file on the network, in particular the data processing device. The determination of the monitoring parameter is preferably dependent on the number of files of the network, in particular of the data processing device, opened by the user, wherein in particular the number of files opened by the user comprises at least one action, preferably all actions of the following group: opening, reading, writing, renaming, copying and deleting a file in the network, in particular on the data processing device. All of the above actions require access to the file in question. The number of files opened by the user is therefore a suitable measure for the monitoring parameter for the access of the user to files on the network, in particular on the data processing device. To detect large numbers of parallel copying and/or encryption operations, also known as bulk operations, the monitoring parameter can take into account the number of files currently opened by a user. Since the monitoring parameter can depend on the number of files opened by the user on the network, in particular on the data processing device, not only the encryption of the affected files on the network, in particular on the data processing device, but also unauthorized copying and/or renaming. It is therefore irrelevant whether the user wants to not only copy files but also encrypt them. This includes any access to the data on the network, especially the data processing device. In this respect, the data on the network, in particular the data processing equipment, is also protected against unauthorized copying, for example by email or a portable medium, which is also referred to as “data loss prevention”.

The procedure is also suitable for detecting unauthorized access to the network, in particular to the data processing device, as early as possible. Each of the aforementioned actions preferably leads to an incremental increase in the monitoring parameter, wherein the increase can be individually weighted depending on the action and/or the user. Within the meaning of the invention, the monitoring parameter can comprise at least one value, preferably a plurality of values, wherein the value can be designed as a binary, integer, floating point value, character, character string and/or Boolean value.

The location information assigned to the network, in particular the data processing device, and/or the user can correspond to the location of the network, in particular the data processing device, and/or the user, wherein the location is determined in particular via the IP address and/or by means of location detection, for example GPS. In contrast to location determination using an IP address, which derives the location information only indirectly as location information assigned to the IP address and thus easily manipulated, the actual geographical location is recorded directly within the framework of location detection. The monitoring parameter corresponds in particular to the distance of the user's location from the location of the network, in particular from the data processing device. In this case, the first limit value may comprise in particular a predefined distance value. If, when comparing the monitoring parameter with the first limit value, it is determined that the user's location is further away from the location of the network, in particular from the data processing device, than the predefined distance value, this can be regarded as a threat, so that the access if the user to the network, in particular to the data processing device, is disconnected according to the invention. This design corresponds to a particularly effective implementation of the principle of location-dependent authorization for users of a network, in particular of the data processing device.

The monitoring parameter can be determined over a predefined period of time, which is defined in particular by an administrator of the network, in particular of the data processing device. One such period is, for example, the duration of the user's session. In addition, a suitable time period can be defined individually for each user. The period can also be a fixed time interval, such as one hour or one second. Determining the monitoring parameter over a period of time enables better comparability of the monitoring parameter. The monitoring parameter is determined over the period of time, for example, by forming a maximum value, an average value and/or a cumulative, in particular added, value.

The first limit value can be predefined, specifically by a network administrator, in particular the data processing device, and/or is determined by a learning phase over a period of time, in particular a user-defined period of time. The first limit can, for example, be a static size and/or correspond to a maximum permitted number of file openings by the user. The first limit can also be set on a user-specific basis. The invention can provide that the first limit value can be changed by the administrator of the network, in particular of the data processing device, in particular for a defined time interval. In an advantageous development of the invention, the learning phase corresponds to a monitoring operation of the method according to the invention, in which the normal, inconspicuous behavior of the user is evaluated over a period of time, for example four weeks.

The first limit can be determined based on at least one monitoring parameter specified over a period of time, which can, for example, correspond to the number of files opened by the user within an hour. The results of the learning phase, in particular the monitoring parameters determined during learning phase, are preferably logged and/or stored in a database. Within the meaning of the invention, the learning phase of the method according to the invention serves to determine the behavior of an inconspicuous user by determining the first limit value. If the user opens malicious files in the future and is infected with ransomware, the method according to the invention registers the conspicuous behavior due to a significant deviation of the monitoring parameter from the first limit value and in this case makes it possible to selectively and quickly block the user from further access to the network, in particular to the data processing device, in particular to its files, so that damage is avoided. At the same time, many files on the network, in particular on the data processing device, can be easily edited during regular operation, provided that the user's behavior corresponds to the behavior determined to be normal during the learning phase or, in particular, that an approved exception has been granted by a higher authority, for example by an administrator of the network, in particular on the data processing device.

The access of the user to the network, in particular to the data processing device, can be disconnected by at least one step from the following: ending the current network session, in particular the current session of the data processing device, of the user, denying the user further access to at least one file, preferably to all files of the network, in particular of the data processing device, and blocking at least one user-defined port of the user for access to the network, in particular to the data processing device, for example blocking user access to a port of the network, in particular of the data processing device, which is assigned to the Server Message Block (SMB), in particular blocking user access to port 445 of the network, in particular of the data processing device. By immediately terminating the user's current network session, and thus also all files that the user has open, it is ensured that further malicious actions by the user in the network, in particular with regard to the data processing device, are prevented. The same applies to the denial of further access to at least one file on the network, in particular the data processing device, which can be done, for example, by changing the user's authorization, in particular by denying the user's access authorizations. By blocking user access to the port mentioned, which is initiated, for example, by means of a local firewall rule relating to the user and/or by means of an appropriately defined protocol, preferably the “Internet Protocol Security (IPSec)” protocol, further interaction of the user with the network, in particular with the data processing device, is prevented on the user side. By combining the steps of the above-mentioned group, effective protection of the network, in particular of the data processing device, is possible.

The access of the user to the network, in particular to the data processing device, can be disconnected by denying at least one access authorization of the user, in particular by denying all access authorizations of the user. Within the meaning of the invention, the denial of an access authorization comprises the withdrawal of a previously granted access authorization and the active allocation of a denial for this access authorization, which is also referred to as denial authorization. This prevents further interaction of the user with the network, in particular with the data processing device, and protects the network, in particular the data processing device, from further damage. This ensures that once access is disconnected, files can no longer be read, modified or deleted.

A user group can be created before the monitoring parameter is determined, wherein each member of the user group is denied write and/or read authorization, in particular any access authorization, and when the access of the user to the network, in particular to the data processing device, is disconnected, the user is assigned to the user group. When the user is assigned to the user group, access authorizations are automatically denied, so that the user's further access to the network, in particular to the data processing device, is immediately blocked. By assigning an active denial of access authorization in the user group mentioned above, all access authorizations already granted, for example by assigning the user to other user groups, are overwritten. The denial of access authorization can be assigned to at least one element of the network, in particular the data processing device, for example at least one file and/or at least one folder of the network, in particular the data processing device, preferably all elements of the network, in particular the data processing device, wherein access to a predefined help page may still be possible as an exception.

The output of a warning signal to the user and/or to an administrator of the network, in particular of the data processing device, is preferably provided as a function of a comparison of the monitoring parameter with a second limit value which is different from the first limit value, in particular is smaller than the latter.

The second limit value can correspond to a warning value, whereby, for example, exceeding the warning value is intended to signal to the user and/or the administrator of the network, in particular of the data processing device, by means of the warning signal that there may be slightly conspicuous behavior on the part of the user that differs from the user's normal behavior, but before the first limit value has already been exceeded and the access of the user to the network, in particular to the data processing device, is disconnected. The second limit value can be predefined in particular by an administrator of the network, in particular of the data processing device. In addition, the determination of the second limit value can be dependent on the first limit value and/or can be carried out by a further learning phase, the type of which has already been described above in connection with the first limit value. The second limit can be set depending on the user. The warning signal can be designed as a notification that is displayed to the user and/or the administrator. In addition, the warning signal can be an automatically sent email to the user and/or the administrator. A warning signal may be issued if the access of the user to the network, in particular to the data processing device, is disconnected.

For further access control, the method can provide a query as to whether the user is present in an existing user database of the network, in particular of the data processing device, and the disconnection of the access of the user to the network, in particular to the data processing device, if the user is not present in the user database. This ensures that only users listed in the user database are granted access to the network, in particular to the data processing device. The user database can be modified by an administrator of the network, in particular of the data processing device. The user database is preferably created by an administrator of the network, in particular the data processing device, before the user accesses the network, in particular the data processing device. The user database may include the users and the monitoring parameters and/or limit values assigned to a user, preferably determined during the learning phase.

To adapt the method according to the invention, the first limit value and/or the second limit value can be changed during the method, preferably by an administrator of the network, in particular of the data processing device, wherein the change can be made by means of remote access, for example by means of a web front end for the administrator.

The at least one data processing device of the network according to the invention can have a file management service, such as a file server, which is designed to carry out the method according to the invention. The computer program is preferably executable on a data processing device of the network according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of a device according to the invention;

FIG. 2 shows a method according to the invention in a flowchart; and

FIG. 3 shows a further example of the method according to the invention in a flowchart.

### DETAILED DESCRIPTION

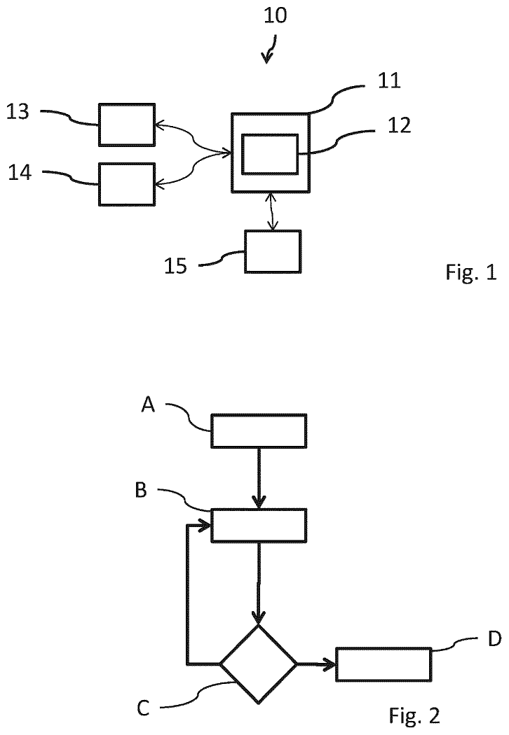

FIG. 1 shows a schematic sketch of a network 10 according to the invention with a data processing device 11, which is shown as a single computer for the sake of simplicity, wherein the network 10 can comprise several data processing devices 11. The computer 11 has a file server 12 which is designed to carry out the method according to the invention. To the left of the computer 11, two users 13, 14 are shown requesting access to the network 10, here the data processing device 11, which is shown by lines with arrows. In addition, an administrator 15 arranged at the bottom in FIG. 1 has access to the network 10, in particular to its file server 12 assigned to the data processing device 11, for example by means of a web front end, and can define or change the parameters described below. In the following, the method according to the invention is explained for a single user 13, although the method can be carried out with respect to several users 13, 14.

FIG. 2 shows an example of the method according to the invention in a flow chart, wherein the user 13 already has access to the network 10, in particular to the data processing device 11; authentication and authorization of the user 13 have already occurred so that the user 13 has access to a released data resource of the network 10. On the file server 12, the user 13 is assigned a corresponding user session for the duration of their access to the network 10. In addition, the first limit value (quota value) Q has already been set to 50 by the administrator 15 of the network, wherein the first limit value Q has been assigned to the user 13 and stored, for example, in a database of the network 10. In addition, a user group was created on the computer 11 or file server 12, whose members are automatically denied all access permissions. This ensures that from the moment of their assignment to this user group, user 13 can no longer access any data, in particular can no longer read, change, copy or delete files. The user group is therefore also referred to as a local denial group. All of the above-mentioned preparatory steps are shown as process step A in FIG. 2.

In a further method step B, a monitoring parameter P is determined which takes the access of the user 13 both to services of the network 10 and to its files into account. As part of determining the monitoring parameter P, in the present example, it is checked for the entire duration of the access of the user 13, i.e., during the user session, whether the user 13 deactivates the system service “Volume Shadow Copy” of the computer 11 of the network 10. As long as this is not the case, no change in the monitoring parameter P occurs, so that as a result of the subsequent comparison C of the monitoring parameter P with the first limit value Q, no disconnection D of the access of the user 13 to the network 10 occurs and the user 13 continues to have access to the network 10. In this case, the procedure continues with the determination B of the monitoring parameter P. However, if the user 13 deactivates the system service “Volume Shadow Copy”, the monitoring parameter P is set to a value of 999. As a result of the comparison C then made between the monitoring parameter P and a first limit value Q, which was set to a value of 50 by the administrator 15 of the network 10 in the present example, the monitoring parameter P, with a value of 999, is greater than the first limit value Q. In an example of the invention, the monitoring parameter P can comprise a Boolean value which is set to “true” when a deactivated system service is detected, which is registered by the comparison with the first limit value Q, which has the value “true”. In this case, the method provides for the disconnection D of the access of the 13 to the network 10, regardless of the access of the user 13 to files on the network 10, which will be explained below. This is done by immediately terminating the session of user 13 and disconnecting all files that user 13 currently has open. In addition, user 13 is assigned to the local denial group, so that further access to files on network 10 is no longer possible due to membership of the user 13 in the local denial group. In addition, an email is sent to the user 13 and to the administrator 15 of the network to point out the suspicious behavior of the user 13. The disconnection D of the access of the user 13 to the network 10 can only be revoked by the administrator 15.

Alternatively or additionally, method step B can provide for the determination of the location of the user 13 as part of the determination of the monitoring parameter P, so that the monitoring parameter P corresponds to the distance of the location of the user 13 from the location of the network 10, which in the present example is represented by the data processing device 11, which is usually known. The first limit value Q has a predefined maximum distance, which is compared with the distance of the location of the user 13 from the location of the network 10 according to method step C within the scope of the comparison according to the invention. If it is determined that the location of the user 13 is further from the location of the network 10 than the predefined maximum distance, the disconnection D of the access is initiated.

Furthermore, the method according to FIG. 2 provides that the determination B of the monitoring parameter P is also dependent on the access of the user 13 to files of the network 10, wherein the monitoring parameter P in the present example of FIG. 2 corresponds to the number of files opened by the user 13 per hour and wherein the number of files opened by the user are referred to as file handles and logged. Accordingly, the predefined value of the first limit or quota value of 50 means that user 13 is inconspicuous as long as user 13 opens fewer than 50 files per hour. If the user 13, for example due to a ransomware infection, begins to copy, modify and/or delete files relatively quickly and frequently, the monitoring parameter P exceeds the first limit value Q, which is detected by the process step C of the comparison. Accordingly, the disconnection D of the access of the user 13 to the network 10 is initiated in the manner already described. As long as the monitoring parameter P is smaller than the first limit value Q, the procedure continues with the determination B of the monitoring parameter P.

While the disconnection D of the access of the user 13 to the network 10 according to the method according to FIG. 2 can have two causes, namely an unauthorized termination of a service and/or a conspicuously high number of file openings, in both cases the disconnection D of the access of the user occurs.

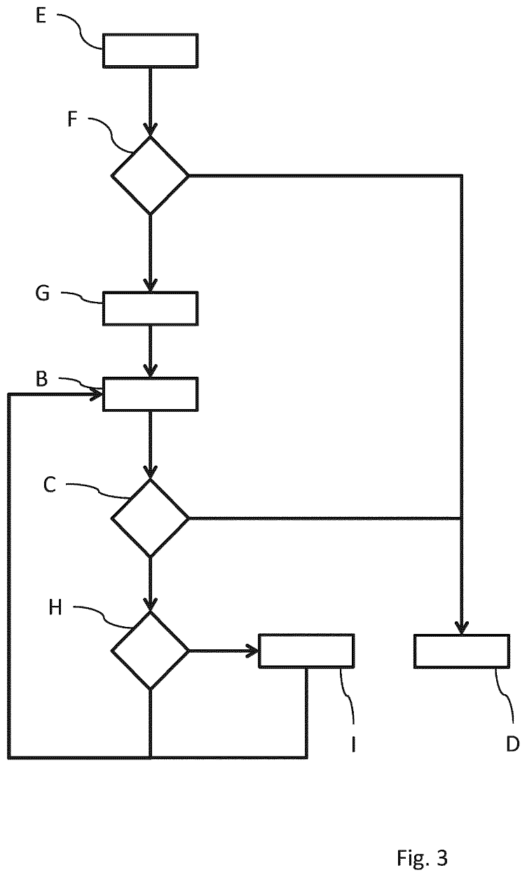

FIG. 3 shows a further example of the method according to the invention in a flowchart; First, the administrator 15 of the network 10 creates a user database, which in the present example contains the user 13 (process step E). If a user 13 requests access to the network 10, a query F is made in a process step as to whether the user 13 is included in the user database. If this is not the case, the access request of user 13 is already perceived as a suspicious action and access is disconnected. Only if the user 13 is included in the user database, the procedure continues and access to the network 10 is granted.

In addition, the procedure in step E provides for the creation of a user group whose members are actively denied all access authorizations. When a user 13 is assigned to this user group, all access authorizations of this user 13 are immediately denied, so that the user 13 can no longer initiate any interactions with the network 10. In this respect, the user group is also referred to as a local denial group.

For an individually adapted determination of the first limit value Q, a learning phase G is provided in particular, during which the behavior of the user 13 with files of the network 10 is determined over a predefined period of time. In the present example, the evaluation of the behavior of the user 13 at the end of the learning phase shows that the user 13 opens, writes, copies or deletes on average about 20 files per hour, which corresponds to 20 file handles. On this basis, at the end of the learning phase G, a second limit value R, also referred to as the warning value, is set to a value of 25 and the first limit value Q is set to a value of 50, thereby ending the learning phase G of the procedure. The second limit value R is a warning value that is comparatively slightly greater than the determined average value of the specific file handles of user 13 in order to take statistical fluctuations into account. In contrast, the first limit value Q is significantly greater than the determined average file handles of the user 13 during the learning phase G. The dependence of the monitoring parameter P on the access of the user 13 to services of the network 10 is not influenced by the learning phase G.

In the further course of the method, the monitoring parameter P is determined in the manner already described in connection with the method according to FIG. 2 (method step B), in which context it is checked whether the user 13 deactivates system services, in the present example, for example the system service “Volume Shadow Copy”. In the method according to FIG. 3, the disconnection D of the access of the user 13 to the network 10 also occurs depending on the comparison C of the monitoring parameter P with the first limit value Q if the user 13 deactivates the “Volume Shadow Copy” system service as already described in connection with FIG. 2, regardless of the result of the learning phase G. In this case, the method immediately causes the disconnection D of the access of the user 13 to the network 10. The current session of user 13 is immediately disconnected. In addition, user 13 is assigned to the user group already described, which means that all access rights of user 13 may be denied. This last measure ensures that even after user 13 accesses network 10 again, user 13 can no longer interact with the network 10 and can no longer perform any further potentially harmful actions. In addition, port 445 is blocked for use by user 13 so that user 13 cannot access network 10 again. At the same time, as in the process according to FIG. 2, an e-mail is sent to the user 13 and to the administrator 15 to point out the conspicuous actions of the user 13. This means that the user 13 cannot copy, encrypt, rename or delete any other data on the network.

Only after the administrator 15 has thoroughly examined the situation can the latter manually authorize the user 13 for further access to the network 10, which means that it can be ensured that the user 13 is no longer infected with malicious software, in particular ransomware.

After determining the monitoring parameter P, a comparison C is made as to whether the monitoring parameter P is greater than the first limit value Q, i.e., whether the monitoring parameter P is greater than 50. If this is the case, the disconnection D of the access of the user 13 to the network 10 occurs in the manner already described. If the monitoring parameter P is smaller than the first limit value Q, the procedure continues. This is followed by a further comparison H to determine whether the monitoring parameter P is greater than the second limit value R, which has a warning value of 25. If this is the case, i.e., if the user 13 has opened more than 25 files per hour during a session, the monitoring parameter P is greater than the second limit value R. In this case, the user 13 continues to have access to the network 10; however, e-mails are sent as warning signals to the user 13 themselves and to the administrator 15 of the network 10, which in particular contain the connection data of the user 13, the time and duration of their access and the files opened (process step I). In this way, both the user 13 and the administrator 15 are made aware of any (still) slightly conspicuous behavior. Regardless of the result of the comparison H, the method according to FIG. 3 is continued, the user 13 retains access to the network 10 and the monitoring parameter P is determined again (method step B).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for controlling an access of a user to a network, the method comprising:
determining a monitoring parameter corresponding to the access of the user to at least one program and/or at least one service and/or at least one file of the network and/or location information associated with the network and/or the user;
comparing the monitoring parameter with a first limit value; and
disconnecting the access of the user to the network depending on the result of the comparison.

2. The method according to claim 1, wherein the method controls the access of a user to a data processing device of the network, wherein the monitoring parameter corresponds to the access of the user to at least one program and/or at least one service and/or at least one file of the data processing device and/or location information associated with the data processing device and/or the user, and/or wherein the access of the user to the data processing device is disconnected depending on the result of the comparison.

3. The method according to claim 1, wherein, in the case in which the user deactivates at least one predefined program or a service of the network, in particular of the data processing device, the monitoring parameter is set to a predefined value such that the disconnection of the access of the user to the network or to the data processing device occurs.

4. The method according to claim 1, wherein the determination of the monitoring parameter is dependent on the number of files of the network or of the data processing device, opened by the user, and wherein the number of files opened by the user comprises at least one action including: opening, reading, writing, renaming, copying and/or deleting a file of the network or of the data processing device.

5. The method according to claim 1, wherein the location information assigned to the network and/or the data processing device and/or the user corresponds to the location of the network and/or the data processing device and/or the user, and wherein the monitoring parameter corresponds to a distance of the location of the user from the location of the network or the data processing device.

6. The method according to claim 1, wherein the monitoring parameter is determined over a predefined period of time, which is defined by an administrator of the network or of the data processing device.

7. The method according to claim 1, wherein the first limit value is predefined by an administrator of the network or of the data processing device, and/or is determined by a learning phase over a user-defined period of time.

8. The method according to claim 1, wherein the disconnection of the access of the user to the network or to the data processing device is carried out by at least one step:
terminating the current network session or the current session of the data processing device of the user;
denying the user further access to at least one or all files of the network or of the data processing device; and/or
blocking at least one user-defined port of the user for access to the network or to the data processing device (11).

9. The method according to claim 1, wherein the disconnection of the access of the user to the network or to the data processing device occurs by denying at least one access authorization of the user by denying all access authorizations of the user.

10. The method according to claim 1, wherein, before the determination of the monitoring parameter, a user group is created, and wherein each member of the user group is denied write and/or read authorization or any access authorization, and upon disconnection of the access of the user to the network or to the data processing device, the user is assigned to the user group.

11. The method according to claim 1, wherein a warning signal is outputted to the user and/or to an administrator of the network or of the data processing device, depending on a comparison of the monitoring parameter with a second limit value which is different from the first limit value or which is smaller than the first limit value.

12. The method according to claim 1, further comprising:
performing a query as to whether the user is present in an existing user database of the network or of the data processing device; and
disconnecting the access of the user to the network or to the data processing device if the user is not present in the user database.

13. A network comprising at least one data processing device which is designed to carry out the method according to claim 1.

14. A computer program comprising program code to carry out the steps of the method according to claim 1 if the computer program is run on a computer or a corresponding computing unit or a data processing device of a network.
